(19) United States
(12) Patent Application Publication
(10) Pub. No.: US 2014/0068212 A1
(43) Pub. Date: Mar. 6, 2014

(54) DEVICE BACKUPS AND UPDATES IN VIEW OF DATA USAGE STATISTICS

(71) Applicant: MICROSOFT CORPORATION, Redmond, WA (US)

(72) Inventors: Austin K. Lin, New York, NY (US); Katharine Holdsworth, Kirkland, WA (US); Klorida Miraj, Issaquah, WA (US); Kyle Joseph Smith, Quezon City (PH); Hung Dang, Seattle, WA (US); Eric D. Cherba, Kirkland, WA (US); Glenn Davis, Woodinville, WA (US); John Menter, Redmond, WA (US); John Chadwell Spaith, Bellevue, WA (US)

(73) Assignee: MICROSOFT CORPORATION, Redmond, WA (US)

(21) Appl. No.: 13/721,057

(22) Filed: Dec. 20, 2012

Related U.S. Application Data
(60) Provisional application No. 61/696,667, filed on Sep. 4, 2012.

(51) Int. Cl. G06F 12/16

(52) U.S. Cl. CPC G06F 12/16
USPC 711/162

(57) ABSTRACT

Embodiments manage data transfer requests representing backup operations and update operations from a computing device using a centralized data transfer service. The data transfer service selects the data transfer requests for performance based at least on data usage statistics associated with a data usage plan and available network connections on the computing device. For the backup operations, the data transfer requests are also selected based on priority information associated with each of the backup operations. In some embodiments, the data transfer service selects and initiates the data transfer requests without incurring excess data transfer costs for the user.

### CROSS-REFERENCE TO RELATED APPLICATION

This application claims the benefit of pending U.S. Provisional Application No. 61/696,667, filed Sep. 4, 2012, the entirety of which is hereby incorporated by reference herein.

### BACKGROUND

With the increased popularity of smart telephones, tablets, and other mobile devices, there has been a similar increase in the amount of data handled by the networks of mobile operators. To reduce the strain on network infrastructure and to reduce network transfer costs, mobile operators are shifting from offering simple unlimited mobile data plans to offering capped and metered plans. Some of these capped and metered plans are complex, with allotted data caps varying based on network type, time of day, etc. Further, the fees for exceeding the allotted data caps may be significant and may also vary based on network type, time of day, etc. The existing systems generally lack mechanisms to help the user understand and manage network data consumption and transfer costs in view of the data usage plans. For example, operations to backup data from the mobile device to a cloud storage service and operations to find and apply updates to the mobile device can potentially consume large amounts of the network data allotted under the data plan.

As a result, with the existing systems, users can unknowingly exceed the allotted data caps and experience bandwidth throttling (e.g., a reduction or limit placed upon the rate of consumption) and/or be presented with a much larger than normal monthly bill, resulting in “bill shock.” Throttling and bill shock can impact the user experience, leading to dissatisfied customers, increased customer service calls, and negative impressions of the mobile operators.

### SUMMARY

Embodiments of the disclosure select backup operations and update operations for initiation based at least on data usage statistics associated with a data usage plan of the device. Data transfer requests representing the backup operations and/or the update operations are received by the device from applications executing on the device. Data usage statistics representing an amount of network data consumed under the data usage plan are determined. One or more of the data transfer requests are selected based at least on the determined data usage statistics and network connections available to the device. For the backup operations, the data transfer requests are also selected based on priority information associated with each of the backup operations. The selected data transfer requests are initiated by the device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a mobile computing device performing data transfer requests received from applications executing on the mobile computing device.

FIG. 2 is an exemplary graph illustrating data usage statistics relative to a linear data usage pattern over a monthly billing cycle.

FIG. 3 is an exemplary flow chart illustrating operation of the computing device or web service to select backup operations to perform based on data usage statistics representing network data consumption.

FIG. 4 is an exemplary user interface illustrating settings associated with the backup operations.

FIG. 5 is an exemplary flow chart illustrating operation of the computing device or web service to select update operations to perform based on data usage statistics representing network data consumption.

FIG. 6 is an exemplary user interface flow illustrating selection and initiation of update operations when a free or reduced cost network connection is available.

FIG. 7 is an exemplary user interface flow illustrating selection and initiation of update operations when there is remaining network data consumption available under a data usage plan, but a free or reduced cost network connection is not available.

FIG. 8A and FIG. 8B represent an exemplary user interface flow illustrating selection and initiation of update operations when there is no remaining network data consumption available under a data usage plan, and a free or reduced cost network connection is not available.

FIG. 9 is an exemplary user interface flow illustrating selection and initiation of update operations when there is remaining network data consumption available under a data usage plan, and a free or reduced cost network connection has been established.

FIG. 10A and FIG. 10B represent an exemplary user interface flow illustrating selection and initiation of update operations in response to a request from a user.

Corresponding reference characters indicate corresponding parts throughout the drawings.

### DETAILED DESCRIPTION

Referring to the figures, embodiments of the disclosure integrate backup operations and/or update operations with a data transfer service 122 to manage network data transfers in view of a data usage plan 116. For example, update detection and download is integrated with the data transfer service 122 or other framework to scan for and download updates with minimal, if any, additional cost to a user 104. The data transfer service 122 executes on a computing device or a web service 108 to leverage data usage statistics 120 when determining how to route network traffic to/from the computing device. This reduces a resource impact to the computing device and/or a cost impact to the user 104 in view of the data usage plan 116 of the user 104.

In some embodiments, aspects of the disclosure determine which backup operations and update operations to perform, while minimizing the interaction between the user 104 and the computing device. For example, by assigning priority information to the backup operations, the data transfer service 122 prioritizes completion of the backup operation based on the assigned priorities and in view of the data usage statistics 120.

For example, the data transfer service 122 may prevent execution of backup operations when the data usage is predicted to exceed a defined allotment during a particular billing cycle. In such an example, the data transfer service 122 halts data transfers to preserve bandwidth for other operations with higher priority (e.g., operations manually initiated by the user 104) and to reduce any cost impact to the user 104 (e.g., prevent excess data charges).

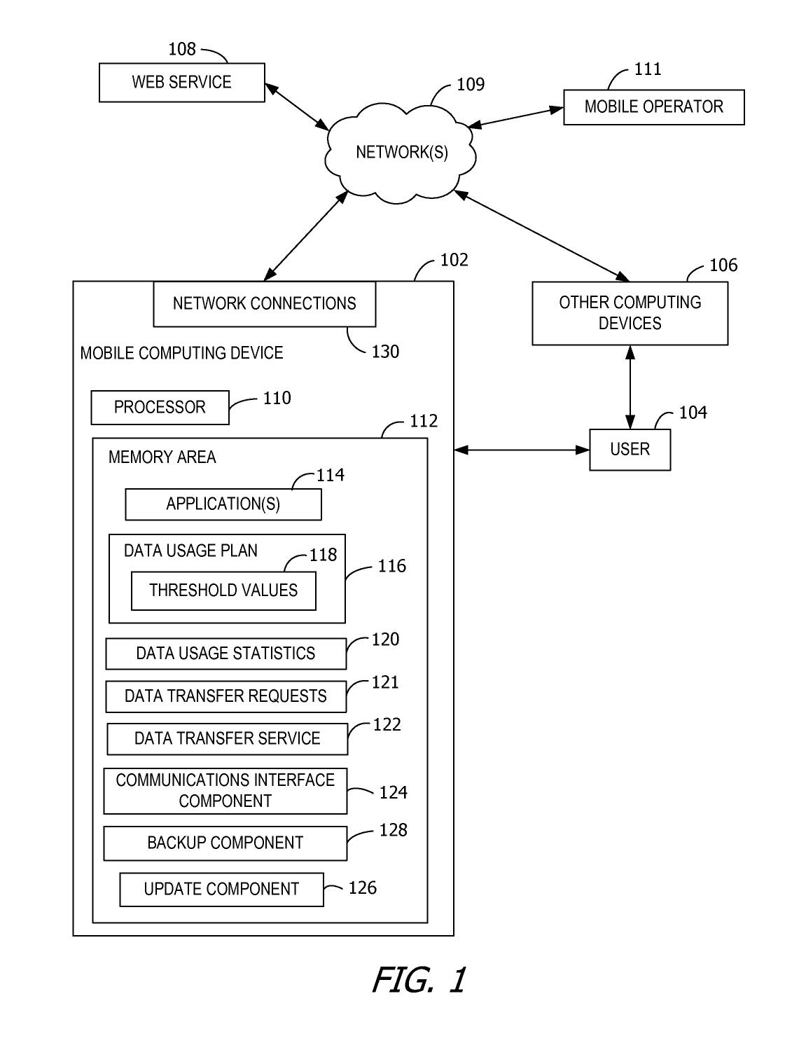

Referring next to FIG. 1, an exemplary block diagram illustrates a mobile computing device 102 performing data transfer requests 121 received from applications 114 executing on the mobile computing device 102. The data transfer service 122 executing on the mobile computing device 102, or in the cloud (e.g., the web service 108), execute to manage backup operations and/or update operation in view of the current data usage statistics 120.

The mobile computing device 102 represents one of a plurality of user computing devices, along with other computing devices 106. The user computing devices communicate over one or more networks 109. In some embodiments, one or more of the user computing devices are associated with one of the data usage plans 116. The data usage plan 116 represents the terms and/or conditions (e.g., network data consumption allotment) under which the mobile operator 111 provides data transfer services to the user computing devices. For example, a plurality of the user computing devices may share network data consumption allotted under the same or common data usage plan 116.

The user computing devices include any device executing instructions (e.g., as application programs, operating system functionality, or both) to implement operations and functionality. The user computing devices may include, for example, the mobile computing device 102 or any other portable device. In some embodiments, the mobile computing device 102 includes a mobile telephone, laptop, tablet, computing pad, netbook, gaming device, e-reader, and/or portable media player. The other computing devices 106 may include less portable devices such as desktop personal computers, kiosks, and tabletop devices that have network connectivity capabilities. Additionally, each user computing device may represent a group of processing units. While aspects of the disclosure may be described herein with reference to the mobile computing device 102, the descriptions are applicable to any of the user computing devices.

Communication to/from the user computing devices may occur using any protocol or mechanism over one or more of the networks 109. The networks 109 represent any infrastructure or other means for sending and/or receiving data. The networks 109 may include wired and/or wireless networks.

One or more mobile operators 111 communicate with the web service 108 and/or the user computing devices via the network 109. Further, the user computing devices communicate with the web service 108, or other entity that performs the operations described herein as being associated with the web service 108.

In some embodiments, the mobile computing device 102 and the other computing devices 106 are associated with a common data usage plan 116 of the user 104. For example, the mobile computing device 102 may represent a mobile telephone of the user 104, while the other computing devices 106 may include a tablet and a laptop associated with the user 104. In other embodiments, the mobile computing device 102 and each of the other computing devices 106 are associated with separate data usage plans 116.

In some embodiments, the centralized web service 108 interacts with the user computing devices and the mobile operators 111 to distribute the data usage plans 116 and to aggregate the data usage statistics 120. For example, the web service 108 receives a schema populated with data relating to the data usage plan 116 from the mobile operator 111 and distributes the populated schema to one or more of the user computing devices associated with the data usage plan 116.

The web service 108 may further generate, monitor, collect, and/or receive the data usage statistics 120 from the mobile operators 111 and from one or more of the user computing devices. The data usage statistics 120 represent an amount of network data consumed by the user computing devices under the data usage plan 116. In some embodiments, the web service 108 reconciles any differences in the data usage statistics 120 received from different sources (e.g., the mobile operators 111 versus the mobile computing device 102).

In some embodiments, the mobile computing device 102 has at least one processor 110, a memory area 112, and at least one user interface (e.g., a touch screen or natural user interface). The processor 110 includes any quantity of processing units, and is programmed to execute computer-executable instructions for implementing aspects of the disclosure. The instructions may be performed by the processor 110 or by multiple processors executing within the mobile computing device 102, or performed by a processor external to the mobile computing device 102. In some embodiments, the processor 110 is programmed to execute instructions such as those illustrated in the figures.

In some embodiments, the processor 110 represents an implementation of analog techniques to perform the operations described herein. For example, the operations may be performed by an analog computing device and/or a digital computing device.

The mobile computing device 102 further has one or more computer readable media such as the memory area 112. The memory area 112 includes any quantity of media associated with or accessible by the mobile computing device 102. The memory area 112 may be internal to the mobile computing device 102 (as shown in FIG. 1), external to the mobile computing device 102 (not shown), or both (not shown). In some embodiments, the memory area 112 includes read-only memory and/or memory wired into an analog computing device.

The memory area 112 stores, among other data, one or more of the applications 114. The applications 114, when executed by the processor 110, operate to perform functionality on the mobile computing device 102. Exemplary applications 114 include mail application programs, web browsers, calendar application programs, address book application programs, messaging programs, media applications, location-based services, search programs, and the like. The applications 114 may communicate with counterpart applications or services such as the web services 108 accessible via the network 109. For example, the applications 114 may represent downloaded client-side applications that correspond to server-side services executing in a cloud.

The mobile computing device 102 further establishes and maintains one or more network connections 130 representing communication channels or other means for sending and/or receiving data over the network 109. Exemplary network connections 130 include, but are not limited to, Wi-Fi, cellular, tethered, BLUETOOTH brand communication, near-field communication (NFC), and more. The network connections 130 may also be categorized into voice, text, data, or other categories or types of network traffic.

The memory area 112 further stores data describing at least one data usage plan 116 associated with the user 104. In some embodiments, the memory area 112 stores a plurality of data usage plans 116. The data describing the data usage plans 116 may be received from the mobile operators 111 offering the data usage plans 116.

The data usage plan 116 may be represented by a schema (e.g., an extensible markup language schema) or other data structure. For example, the user 104 has contracted with the mobile operator 111 to receive network data transfer services from the mobile operator 111. The data usage plan 116 describes the services provided by the mobile operator 111, such as the amount of network data the user 104 can consume during a particular duration (e.g., a billing time period). For example, the data usage plan 116 describes threshold values 118 associated with the network connections 130 of one or more devices of the user 104. The threshold values 118 represent a maximum amount of network data consumption allotted under the data usage plan 116 for the network connections 130. For example, one threshold value 118 may indicate a maximum amount of network data consumption for a Wi-Fi connection, while another threshold value 118 indicates a maximum amount of network data consumption for a cellular data connection.

The schema or other data structure representing the data usage plan 116 may be defined by the web service 108, by the mobile operator 111, or by another entity. In some embodiments, each of the various data usage plans 116 subscribed to by the mobile computing device 102 and the other computing devices 106 use the same common schema. In general, the schema enables descriptions of the parts, components, services, features, or other aspects of the data usage plan 116 including, but not limited to, multi-rate data plans, peak times, roaming rates, allotted network data consumption per network connection 130, etc. In some embodiments, use of the schema allows the mobile operators 111 to send out updated portions of the schema corresponding to updated parts of a particular data usage plan 116.

Aspects of the disclosure are operable with any quantity of populated schemas. Each of the populated schemas is associated with a different one of the data usage plans 116. For example, the mobile computing device 102 may have more than one cellular connection, and each of the cellular connections work independently (e.g., multiple radios operating independently of each other). In such embodiments, there may be multiple data usage plans 116 active per cellular connection. Exemplary environments include dual subscriber identity module (SIM) dual active devices (both connections independently active) or dual SIM dual standby devices (one connection is in a standby mode). Additional examples include virtual SIMs, universal integrated circuit cards (UICCs), and other variants of user identity modules.

In some embodiments, the schema includes a plurality of fields. Each of the threshold values 118 may be associated with one or more of the fields. For example, the fields may correspond to one or more of the following: peak times, off-peak times, peak time network data consumption quota, off-peak time network data consumption quota, peak time network data consumption remaining, off-peak time network data consumption remaining, a roaming rate, rules, a mobile operator name, a billing cycle type, a network connection type, identification of free hosts available for connection, a list of mobile hotspots, and any other elements or information pertaining to the data usage plan 116. The list of free hosts represents zero-rated or reduced cost hosts (e.g., visiting particular web sites does not count against the data usage plan 116).

The schema may also include fields supporting different billing rates per host accessed, per weekend, per night, friends and family rates, peak and off-peak rates, and more. The schema also allows each mobile operator 111 the flexibility to define complex plans including broadly offered plans, and dynamic, short-term offers to specific users 104 likely to use a specific part or parts of the overall services. Other offers based on any combination of the metrics obtained are available to the mobile operator 111.

The schema stored by the mobile computing device 102 may also include fields corresponding to the data usage statistics 120 collected, generated, or received by the mobile computing device 102 and/or the mobile operators 111. For example, to facilitate sharing the data usage statistics 120 among the mobile operators 111, web service 108, and/or user computing devices, the mobile operators 111, web service 108, and the user computing devices may populate the schema with the data usage statistics 120.

While the schema may take any form or structure, the schema may be implemented as XML schema.

The memory area 112 further stores the data usage statistics 120 relating to one or more of the data usage plans 116. The data usage statistics 120 may include a current, instant, or historical snapshot of the amount of data transmitted and/or received by the mobile computing device 102. For example, the mobile computing device 102 collects ongoing usage data relating to network data transfers, such as from device radios, drivers, and accelerometers of the mobile computing device 102. The data usage statistics 120 identify, to a granularity of time (e.g., per minute) or data (e.g., per kilobyte), how much data has been sent and/or received by the mobile computing device 102 (e.g., an amount of data consumed), the time and date of usage, the location of usage, network interface used (e.g., over which network connections 130), the subscriber identity module (SIM) card or other user identity module used for dual SIM scenarios, the international mobile station equipment identity (IMEI) or other device identifier for multi-device scenarios, the Internet protocol (IP) address or other address of the access point used for Wi-Fi scenarios, the IP address or other address of the target computer (e.g., for whitelist/blacklists in data usage), the application responsible for the data transfer, and the like. In a further example, information relating to text messages, data, voice calls, minutes used, voice over Internet Protocol (VoIP) usage, and any other element of usage consumed by, or that impacts, the mobile computing device 102 is collected to produce the data usage statistics 120. Other data usage statistics 120 are also contemplated.

In some embodiments, current data usage statistics 120 represent network data consumed during a portion of a pre-defined time interval. For example, the current data usage statistics 120 may represent the cumulative amount of network data transferred in the current billing cycle.

The data usage statistics 120 may be collected by the mobile computing device 102, the web service 108, and/or the mobile operators 111. For example, the data usage statistics 120 may be compiled directly (e.g., by monitoring network traffic) and/or by collecting the data usage statistics 120 from other devices that perform the collection.

Alternatively or in addition, the mobile computing device 102 receives updates of network data consumption by the other computing devices 106 sharing the same data usage plan 116. For example, the data usage statistics 120 may represent the network data collectively consumed by a mobile telephone, tablet, and laptop of the user 104.

In a further example, the mobile operator 111 collects data usage statistics 120 corresponding to a plurality of data usage plans 116. In such an example, there may be a plurality of sets of data usage statistics 120 (e.g., one set for each data usage plan 116 or user 104).

In some embodiments, the mobile operator 111 may have more current and/or more accurate data usage statistics 120 for one or more of the user computing devices than the user computing devices. For example, the mobile operator 111 may have more current and/or more accurate data usage statistics 120 for particular network connections 130 than the user computing devices. The mobile operator 111 may push, or transmit upon demand, such data usage statistics 120 to the web service 108 and/or to the mobile computing device 102. The web service 108 and/or the mobile computing device 102 integrates or otherwise reconciles the data from the mobile operator 111 and/or the user computing devices to produce the data usage statistics 120, which are then sent to the mobile computing device 102 for storage.

The memory area 112 further stores one or more data transfer requests 121 received from the applications 114. For example, the applications 114 queue their data transfer requests 121 in a queue. In some embodiments, each of the data transfer requests 121 represents a backup operation and/or an update operation. The backup operations each have priority information associated therewith. The priority information reflects the priority placed on the backup operation. The priority information may indicate an absolute priority (e.g., one of a plurality of pre-defined values or levels), a relative priority (e.g., a priority defined relative to a priority associated with another data transfer request 121), a conditional priority (e.g., describing conditions under which the backup operation should be performed), and more.

Exemplary priority information includes priorities such as Explicit, Background, Opportunistic, and Predictive, as described in Table 1 below. Aspects of the disclosure, however, are not limited to the following exemplary priorities or descriptions.

TABLE 1
Exemplary Priority Information.

| Priority | Description |
|---|---|
| Explicit user | This priority is associated with a data transfer request |
| operation | resulting from an action the user has taken, either directly |
| | through the user interface or via a settings page. The action |
| | may be a single or recurring operation that the user expects |
| | to be initiated, invoked, and/or completed based on time or |
| | event. The data transfer request is known or expected to |
| | consume data, and the data transfer request should not be |
| | deferred. |
| Background | This priority is associated with a data transfer request |
| (e.g., explicit | resulting from a user action that does not directly request to |
| intent/ | consume data. If the data transfer request is not completed |
| implicit core | immediately, or at a specified time, the user experience will |
| experience) | not be impacted negatively, but may lead to visible, |
| | noticeable, and/or perceptible differences in the user |
| | experience. |
| Opportu- | This priority is associated with a data transfer request that, |
| nistic | if not completed at a specified time, will not impact the |
| operation | user experience negatively. The data transfer request may |
| (e.g., | be scheduled when there is a low or very low risk of |
| deferred | exceeding the threshold values under the data usage plan. |
| operation) | |
| Predictive | This priority is associated with a data transfer request that |
| operation | does not have a specific target completion time, but should |
| | rather be performed upon detecting appropriate |
| | opportunities based on heuristics. |

As an example, the priority information may specify that backup operations are to be performed only when a Wi-Fi network connection is available, only when a free or reduced cost network connection 130 is available, and/or only after receiving manual or otherwise explicit authorization from the user 104.

The data transfer service 122 executing on the mobile computing device 102 to process the data transfer requests 121 accesses the queue to analyze, select, and initiate the data transfer requests 121, as further described herein.

The memory area 112 further stores exemplary computer-executable components such as a communications interface component 124, a backup component 128, and an update component 126. Operation of the computer-executable components, when executed, is described herein.

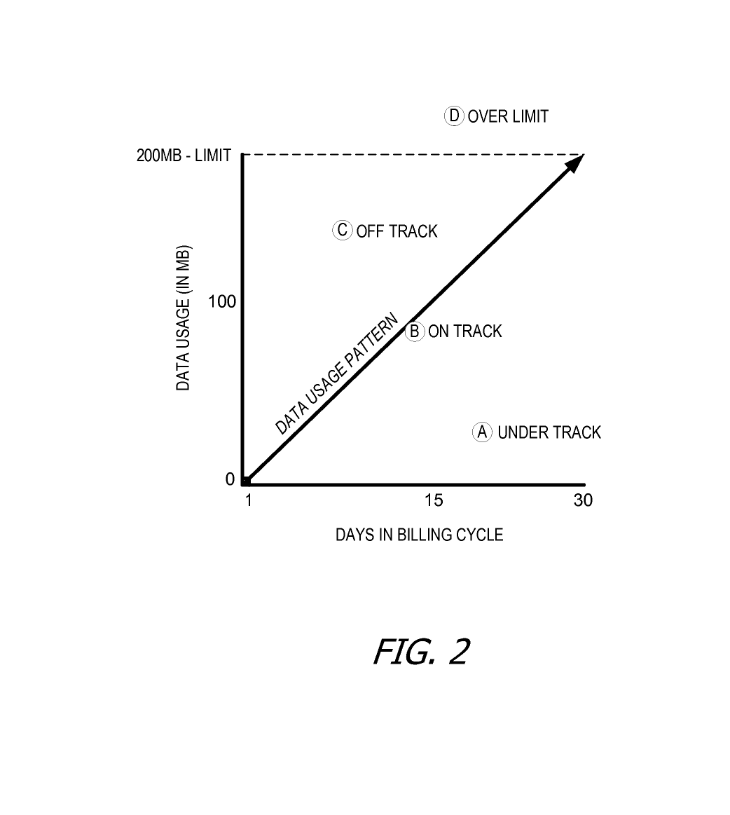

In some embodiments, the data transfer service 122 that selects and initiates the backup operations and the update operations relies on data usage states that are part of, or inferred from, the data usage statistics 120. For example, while the data usage statistics 120 may represent amounts of network data consumed during a current billing cycle, the data usage statistics 120 may further include or produce a data usage state corresponding to the network data consumption amounts. Exemplary data usage states include, but are not limited to, On Track, Off Track, Over Limit, or Under Track, and may be described relative to a historical data usage pattern. The relationship of these data usage states to the data usage pattern is described next with reference to FIG. 2.

Referring next to FIG. 2, an exemplary graph illustrates data usage statistics 120 relative to a linear data usage pattern over a monthly billing cycle. While a linear data usage pattern is illustrated in FIG. 2, other data usage patterns such as non-linear patterns are contemplated. In general, the shape of the curve is fit to, or otherwise dependent on, the pattern of the usage (e.g., the data usage pattern). For example, the data usage patterns may be based on the historical network data consumption of the user 104 and/or other users 104. The data usage state assigned to a particular network data consumption value changes based on the position of the network data consumption value relative to the curve representing the data usage pattern.

For example, the data usage states indicate or predict whether the user 104 is likely to use most or all of the network data allotted under the data usage plan 116, use less than the allotted network data, or use more than the allotted network data, in some embodiments. Comparing the current data statistics with the data usage pattern enables the computing device to predict future network data consumption by the user 104.

The computing device may further compare the accessed current data usage statistics 120 to the threshold values 118 available from the data usage plan 116. The threshold values 118 represent an allocation of network data consumption for each of the network connections 130. For example, the computing device 102 may track a cumulative amount of data transfers occurring over each of the network connections 130. The computing device 102 compares the tracked, cumulative amounts (representing the current data usage statistics 120) to the corresponding threshold values 118 associated with each of the network connections 130. By comparing the current data usage statistics 120 to the threshold values 118, the computing device determines how much network data consumption remains available for each of the network connections 130. The remaining amount of network data consumption may be presented or displayed to the user 104, such as in the user interface.

In the example of FIG. 2, the exemplary data usage plan 116 indicates that 200 megabytes (MB) is the threshold value 118 for a particular network connection 130 type (e.g., cellular) each month. Other threshold values 118 (e.g., other than 200 MB) and other billing periods (e.g., other than one month), however, are contemplated. The line in the graph in FIG. 2 reflects the expected linear usage of the 200 MB over the course of the month.

The computing device 102 (and/or the mobile operator 111) tracks the data consumption by the user 104 and/or computing device 102 to generate the data usage statistics 120. In other embodiments, the data usage statistics 120 are received from another entity performing the tracking. The circles A, B, C, and D in the graph represent plotted examples of different network data consumption values from the data usage statistics 120 at particular days in the month. For ease of comparison, the four exemplary values are plotted in the same graph. The location of the circles relative to the curve representing the data usage pattern indicates whether the computing device determines that the network data consumption of the user 104 and/or computing device 102 is Off Track (e.g., Circle C—above the linear usage line, the user 104 is on track to exceed 200 MB of data consumption before the end of the month), On Track (e.g., Circle B—approximately matching the linear usage line, the user 104 is on track to consume 200 MB around the end of the month), or Under Track (e.g., Circle A—below the linear usage line, the user 104 is not on track to consume the full 200 MB before the end of the month).

Given the day of the billing cycle and the current or up-to-date data consumption for the billing period, an extrapolation or projection is performed to predict the consumption associated with the end of the billing cycle. In some embodiments, Off Track may be defined as the user 104 being on or above the projected limit (e.g., the value of the curve) given the day within the billing cycle and the current or up-to-date data consumption for the billing period. Similarly, On Track may be defined as the user 104 being at least 5% below the projected limit given the day of the billing cycle and the current or up-to-date data consumption for the billing period. Under Track may be defined as the user 104 being at least 20% below the projected limit given the day of the billing cycle and the current or up-to-date data consumption for the billing period. In some further embodiments, if the data usage is within 10% of the limit for a particular network connection 130 at any point during the billing period, the data transfer service 122 executing on the computing device may halt data transfer requests 121 using that network connection 130.

Some embodiments contemplate an “Over Limit” category that allows users 104 to opt out of data consumption by background transfers unless the background transfers are user-initiated or deemed critical. In the example of FIG. 2, Circle D corresponds to an exemplary network data consumption value that prompts the computing device to conclude that the user 104 is in the Over Limit data usage state.

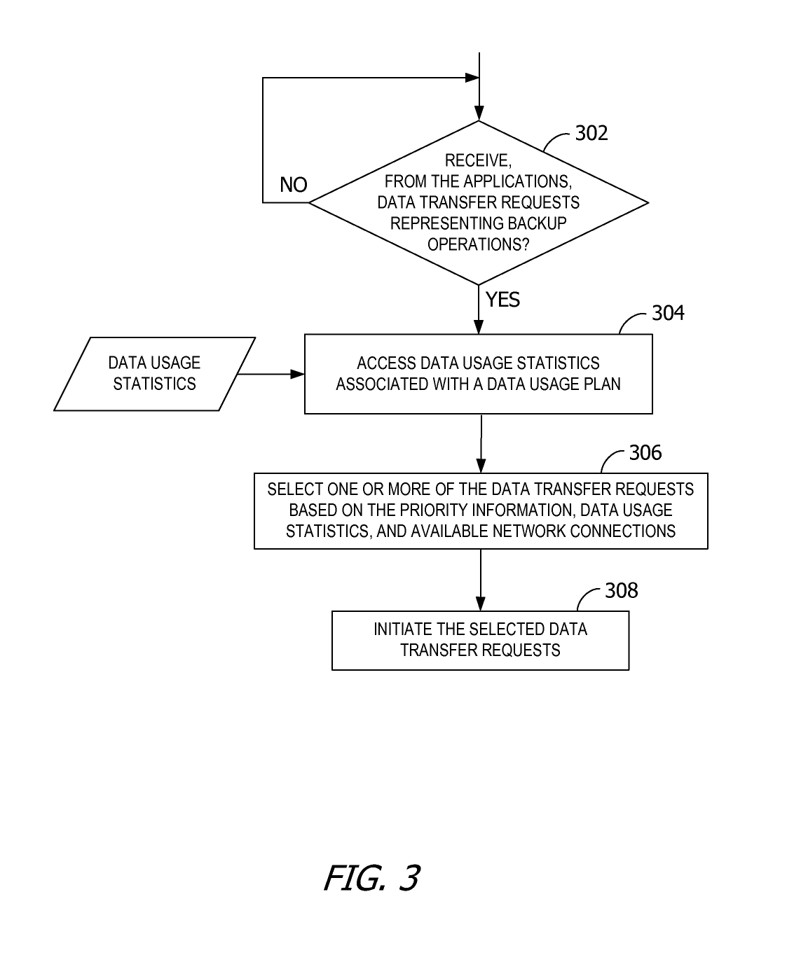

Referring next to FIG. 3, an exemplary flow chart illustrates operation of the computing device or web service 108 to select backup operations to perform based on the data usage statistics 120. While the operations illustrated in FIG. 3 are described as being performed by the mobile computing device 102 or the web service 108 in some embodiments, one or more of the operations may be performed by other devices, including any computing device local to, or remote from, the user 104. For example, the operations may be performed by a proxy device in communication with the mobile computing device 102. Further, in some embodiments, the operations illustrated in FIG. 3 are performed by the data transfer service 122 executed by an operating system executing on the mobile computing device 102.

The data transfer service 122 intermittently or continually checks if at least one of the data transfer requests 121 at 302 that represents a backup operation has been accessed or otherwise received. The backup operation has priority information indicating the conditions, settings, or urgency associated with performance of the backup operation.

The data transfer service 122 accesses data usage statistics 120 at 304. As described herein, the data usage statistics 120 represent an amount of network data consumed under the data usage plan 116. For example, the data usage statistics 120 indicate whether the user 104 is above or under the allotted amount of network data consumption, on track or off track for consumption within a billing cycle, etc.

In the example of FIG. 3, another thread or routine periodically determines or calculates the data usage statistics 120 and makes those available to the data transfer service 122. For example, the thread calculates the data usage statistics 120 separately and independently from the data transfer service 122. In other embodiments, however, the data transfer service 122 calculates the data usage statistics 120 in response to receiving the backup operation from one of the applications 114, to obtain the latest or most up-to-date data usage statistics 120.

At 306, the data transfer service 122 selects one or more of the received data transfer requests 121 based on the priority information, the data usage statistics 120, and/or the available network connections 130. In an example in which a plurality of backup operations are received, the data transfer service 122 orders the backup operations based on the priority information, determines which network connections 130 are available, and determines which of the network connections 130 have remaining network data consumption based on the data usage statistics 120. The data transfer service 122 then matches the backup operations having the highest priorities with the network connections 130 for which network data consumption remains under the data usage plan 116. At 308, the data transfer service 122 initiates the selected one or more data transfer requests 121 on the matched network connections 130. In this manner, the backup operations are performed sensitive not only to the priority information, but also to the network data consumption.

The priority information may be provided by the application 114 creating the data transfer request 121. For example, the application 114 may assign the priority information to the data transfer request 121, or to the underlying backup operation. In other embodiments, the data transfer service 122 assigns the priority information to the received data transfer requests 121 based on a priority associated with the underlying backup operation.

Alternatively or in addition, the data transfer service 122 may assign the priority information in other ways. For example, the data transfer service 122 may tag each application 114 upon execution of the application 114 to identify those applications 114 executing frequently and/or recently. In such an example, the data transfer service 122 adds each application 114, upon execution, to a most-recently-used (MRU) list or to a most-frequently-used (MFU) list. Thus, applications 114 that run more often than another applications 114 are at the top of the MFU list for backup based on incremental tag values. The data transfer service 122 maintains the MRU list and the MFU list and performs the backup operations as ordered in these lists upon matching the backup operations to the available network connections 130.

In some embodiments, the data transfer service 122 may adjust the MRU list and/or the MFU list based on the amount of network data actually consumed during performance of the backup operations. For example, if the backup operations of one of the applications 114 consume a large amount of network data, the data transfer service 122 may demote that application 114 within the MRU list and/or the MFU list to enable performance of backup operations from other applications 114.

The computing device 102 may select one or more of the backup operations for initiation across the detected network connections 130 in view of the data usage statistics 120 using match criteria. The exemplary match criteria shown in Table 2 below match the exemplary priority information from Table 1 to the detected network connections 130 in view of exemplary data usage states.

TABLE 2
Exemplary Match Criteria.

| Priority | Match Criteria |
|---|---|
| Explicit user | Match to any network connection when the user is Off |
| operation | Track, On Track, or Under Track |
| Background | Match to any network connection only when the user is On |
| (e.g., explicit | Track or Under Track, or on an unlimited plan (e.g., no |
| intent/ | threshold values or limits). |
| implicit core | |
| experience) | |
| Opportu- | Match to any network connection only when the user is |
| nistic | Under Track, or on an unlimited plan (e.g., no threshold |
| operation | values or limits). |
| (e.g., | |
| deferred | |
| operation) | |
| Predictive | Match to any network connection only when the user is on |
| operation | an unlimited plan (e.g., no threshold values or limits). |

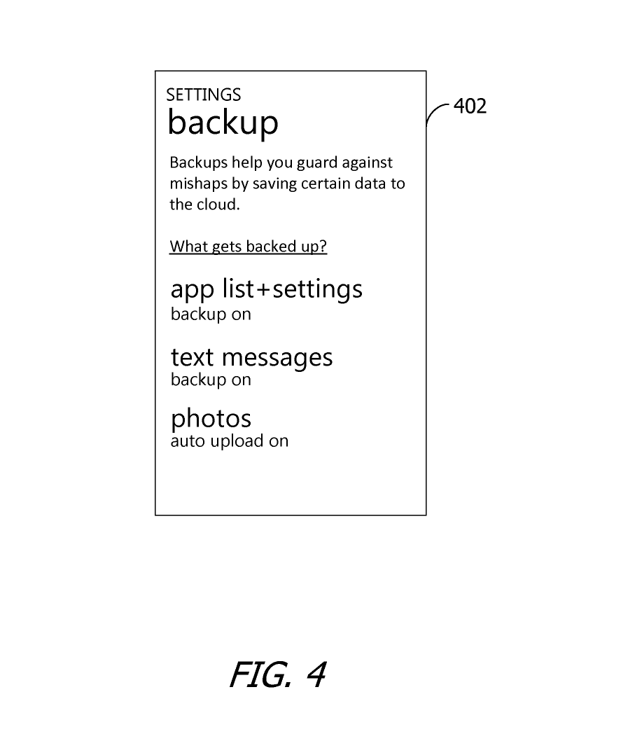

Referring next to FIG. 4, an exemplary user interface 402 illustrates settings associated with the backup operations. The settings shown in FIG. 4 are merely exemplary, and other configuration options are contemplated.

In the example of FIG. 4, the user interface 402 indicates that the list of installed applications 114, the settings for those applications 114, and text messages have been selected for backup. Photos are automatically uploaded to a cloud storage service (e.g., the web service 108) after capture (e.g., at periodic intervals, intermittently, or immediately after capture). The user 104 may also select videos for automatic upload alternatively or in addition to the photos, in some embodiments.

The data transfer service 122 uses the backup settings, such as those illustrated in FIG. 4, in connection with the data usage statistics 120 to perform the backups. That is, the data transfer service 122 performs the backup operations based on the data usage statistics 120 such as shown in FIG. 3. For example, the data transfer service 122 may perform the backup operations only using a Wi-Fi network connection, or other free or reduced cost network connection 130. Some of the backup operations may override any conclusions drawn from the data usage statistics 120, such as when the user 104 issues a manual request to perform an immediate backup operation. In such an example, the backup operation proceeds as soon as the user 104 taps a “Backup Now” button. Before the button is pressed, however, some embodiments contemplate a warning to the user 104 about an overage. In another example, the backup operation proceeds on one of the network connections 130 for which no network data consumption remains under the data usage plan 116 if the backup operation has not been able to complete within a pre-defined time period. For example, if the user 104 has been unable to connect to a Wi-Fi network in the past seven days, the data transfer service 122 proceeds to perform the backup operation over a cellular network connection even if the network data consumption for the cellular network connection already exceeds the threshold value 118 under the data usage plan 116.

In some embodiments, at the time of backup, only data that has changed since the last backup is transmitted to the cloud storage service. In other embodiments, a full backup of the data is transmitted to the cloud storage service at the time of backup. Further, the data stored by the cloud storage service is provisioned by both a user identifier and a device identifier, in some embodiments. This supports examples such as the same user 104 having multiple devices (e.g., tablet, laptop, telephone, etc.).

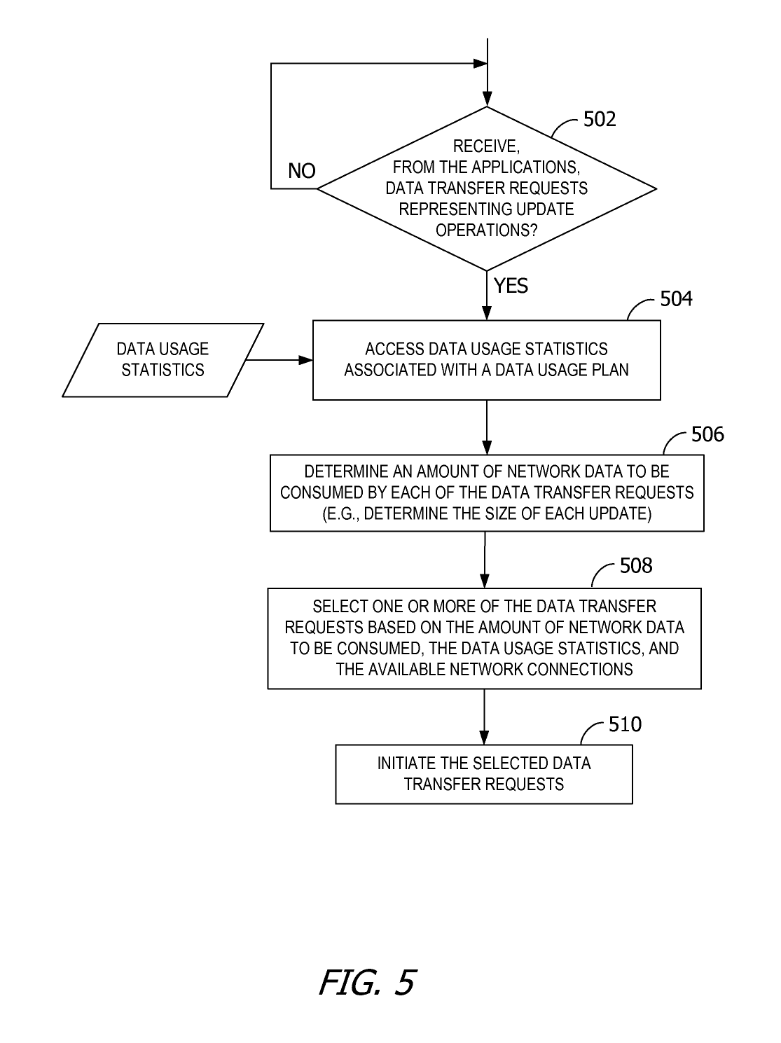

Referring next to FIG. 5, an exemplary flow chart illustrates operation of the computing device or web service 108 to select update operations to perform based on the data usage statistics 120 representing network data consumption. While the operations illustrated in FIG. 5 are described as being performed by the mobile computing device 102 or the web service 108 in some embodiments, one or more of the operations may be performed by other devices, including any computing device local to, or remote from, the user 104. For example, the operations may be performed by a proxy device in communication with the mobile computing device 102. Further, in some embodiments, the operations illustrated in FIG. 5 are performed by the data transfer service 122 executed by an operating system executing on the mobile computing device 102.

The data transfer service 122 intermittently or periodically checks for receipt of update operations in a plurality of data transfer requests 121 from one or more of the applications 114 at 502. At 504, the data transfer service 122 accesses the data usage statistics 120 for the computing device (e.g., the mobile computing device). As described at least in part above with reference to FIG. 3, the data transfer service 122 may access the data usage statistics 120 calculated separately and independently from the data transfer service 122, the data transfer service 122 may calculate the data usage statistics 120 directly, or a combination of both.

At 506, the data transfer service 122 calculates an amount of network data expected to be consumed by each of the update operations. For example, the data transfer service 122 calculates the size of an update to be downloaded (e.g., from the web service 108 or other entity) during performance of each update operation. The update includes, for example, a compressed or uncompressed data file.

At 508, the data transfer service 122 selects one or more of the received data transfer requests 121 based on the data usage statistics 120, on the amount of network data expected to be consumed by each of the update operations, and on the network connections 130 available to the computing device. For example, the data transfer service 122 determines which network connections 130 are available, and compares the expected amount of network data consumption to the remaining network data consumption on each of the available network connections 130. The data transfer service 122 matches the update operations to the available network connections 130 based at least on this comparison, in some embodiments. For example, the data transfer service 122 matches the update operations to the network connections 130 having enough network data consumption remaining to complete the update operation (e.g., download the entire data file associated with the update operation).

At 510, the data transfer service 122 initiates the selected data transfer requests 121 on the matched network connections 130 to perform the update operations associated therewith. The selected data transfer requests 121 may be initiated by the data transfer service 122 automatically, in the background, or otherwise without explicit user input. For example, if there is unlimited data remaining over an available network connection 130 (e.g., the computing device has established a Wi-Fi network connection), the data transfer service 122 initiates the selected data transfer requests 121 automatically. In other embodiments, the data transfer service 122 may prompt the user 104 to confirm initiation of the selected data transfer requests 121. For example, if there is limited data remaining over an available network connection 130 (e.g., no Wi-Fi hotspot is available), the data transfer service 122 prompts the user 104 to confirm initiation of the selected data transfer requests 121. As another example, the data transfer service 122 may prompt the user 104 to confirm initiation of any selected data transfer request 121 that is expected to transfer large amounts of data, whether or not a free or reduced cost network connection 130 is available.

In some embodiments, the data transfer service 122 selects one or more of the received data transfer requests 121 based on update settings specified by the application 114 creating the data transfer request 121 and/or the user 104. In this manner, the user 104 may customize the update experience by, for example, specifying the network connection 130 over which the update operations should be performed. The user 104 interacts with a user interface to specify the settings, and may also view the update status of the computing device, current update activity, past update activity, scheduled update activity, etc. The user 104 may also initiate a scan for updates, re-start a previously postponed update operation, and more.

One or more of the operations illustrated in FIG. 3 and/or FIG. 5 may be performed by the computer-executable components illustrated in FIG. 1. For example, the communications interface component 124, when executed by the processor 110 of the mobile computing device 102, causes the processor 110 to receive a plurality of the data transfer requests 121 from one or more of the applications 114 executing on the mobile computing device 102. Each of the data transfer requests 121 represents an update operation or a backup operation. In some embodiments, at least one of the data transfer requests 121 represents an update operation and at least one of the data transfer requests 121 represents a backup operation.

For the data transfer requests 121 corresponding to backup operations, the backup component 128, when executed by the processor 110 of the mobile computing device 102, causes the processor 110 to select one or more of the received data transfer requests 121 based at least on the priority information and on the data usage statistics 120 associated with the data usage plan 116.

For the data transfer requests 121 corresponding to update operations, the update component 126, when executed by the processor 110 of the mobile computing device 102, causes the processor 110 to select one or more of the received data transfer requests 121 based at least on the data usage statistics 120 and on the available network connections 130.

The communications interface component 124, when executed by the processor 110 of the mobile computing device 102, causes the processor 110 to initiate, on the available network connections 130 as matched by the backup component 128 and the update component 126, the data transfer requests 121 selected by the backup component 128 and by the update component 126, respectively.

In some embodiments, the backup component 128 and/or the update component 126 further determine, from the data usage statistics 120, whether the mobile computing device 102 is under track, on track, or off track for network data consumption compared to an amount of network data consumption allotted under the data usage plan 116 (e.g., the threshold values 118 of the data usage plan 116).

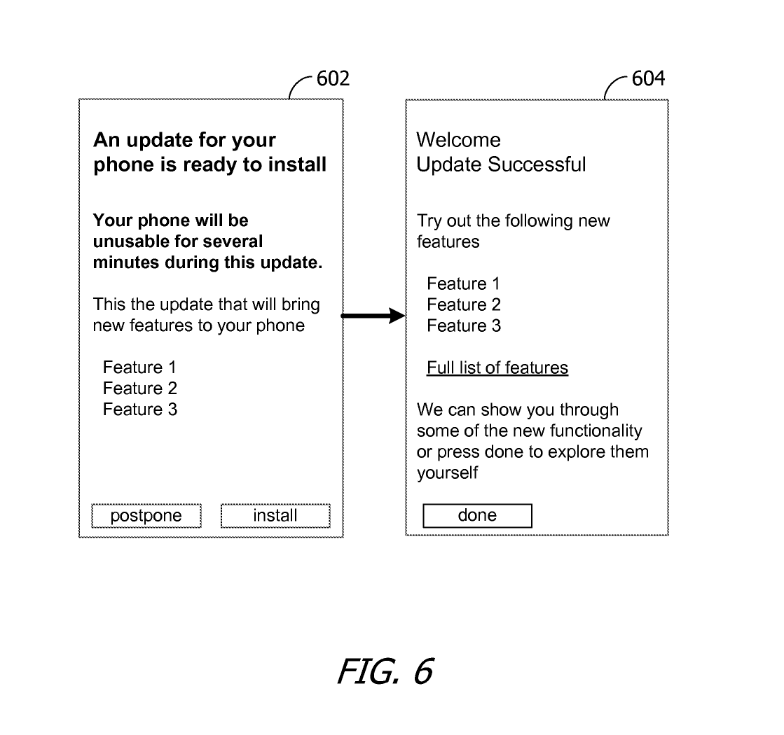

Referring next to FIG. 6, an exemplary user interface flow illustrates selection and initiation of update operations when a free or reduced cost network connection 130 is available. In the example of FIG. 6, the update operations are performed without presenting a download prompt to the user 104 to confirm performance of the update operations.

The user 104 is presented with a dialog 602 indicating that an update is ready to install after the update has been automatically downloaded, in the background, using the free or reduced cost network connection 130. The user 104 is presented with information about the contents of the update and the option to install the update now or postpone installation of the update. Dismissing the dialog brings the user 104 back to the previous activity on the mobile computing device 102, and the dialog 602 is displayed again after some time period (e.g., a few days).

If the user 104 chooses to install the downloaded update, the mobile computing device 102 proceeds to install the update and displays a progress bar for the status of the installation. After committing the update, the mobile computing device 102 presents a dialog 604 showing that the update was successful and outlining a list of new features associated with the update.

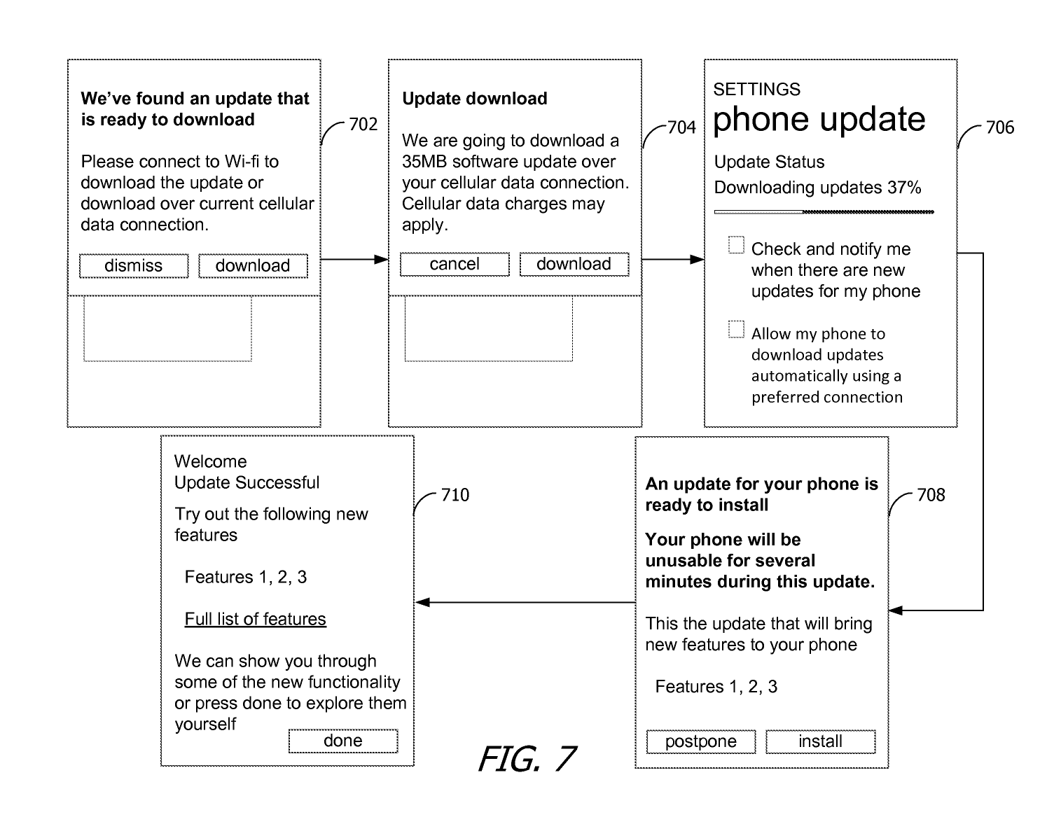

Referring next to FIG. 7, an exemplary user interface flow illustrates selection and initiation of update operations when there is remaining network data consumption available under the data usage plan 116, but a free or reduced cost network connection 130 is not available. In the example of FIG. 7, the update operations are performed after presenting a download prompt to the user 104 to confirm performance of the update operations. Further, in this example, the update is small enough to be downloaded over a cellular network connection.

The user 104 is presented with a dialog 702 indicating that an update is ready to download. In this example, the user 104 does not have an active free or reduced cost network connection 130 to use so the user 104 is prompted to either connect to a Wi-Fi network connection or to download over a cellular data connection. The user 104 may choose to dismiss the dialog 702 if the user 104 is busy or wants to connect to Wi-Fi. Dismissing the dialog 702 brings the user 104 back to the previous activity on the mobile computing device 102 and the dialog 702 is displayed again after some time period (e.g., a few days).

If the user 104 chooses to download now, the user 104 is presented with an anticipated size of the data transfer associated with the update operation in a dialog 704. The user 104 may choose to proceed with the download or to cancel. If the user 104 proceeds with the download, the user 104 is taken to an update settings dialog 706 that shows the progress of the download. Cancelling the dialog 704 brings the user 104 back to the previous activity on the mobile computing device 102 and the dialog 702 is displayed again after some time period (e.g., a few days).

The user 104 is presented with a dialog 708 indicating that an update is ready to install after the update has been downloaded. The user 104 is presented with information about the contents of the update and the option to install the update now or postpone installation of the update. Dismissing the dialog 708 brings the user 104 back to the previous activity on the mobile computing device 102 and the dialog 708 is displayed again after some time period (e.g., a few days).

If the user 104 chooses to install the downloaded update, the mobile computing device 102 proceeds to install the update and displays a progress bar for the status of the installation. After committing the update, the mobile computing device 102 presents a dialog 710 showing that the update was successful and outlining a list of new features associated with the update.

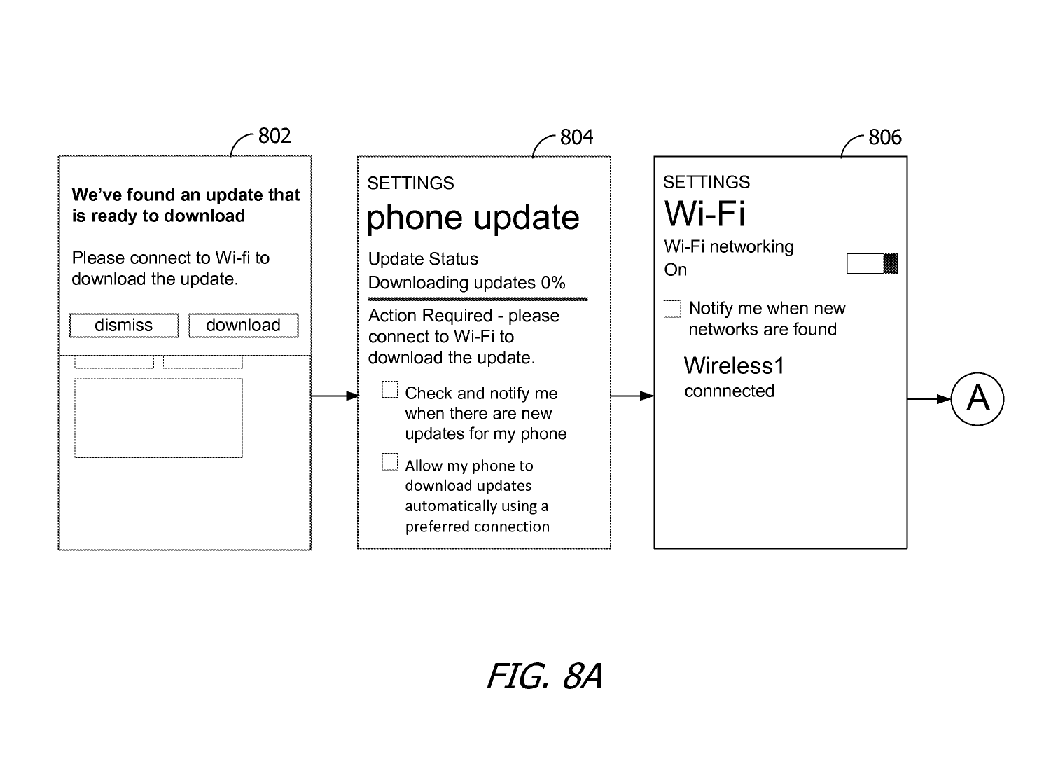

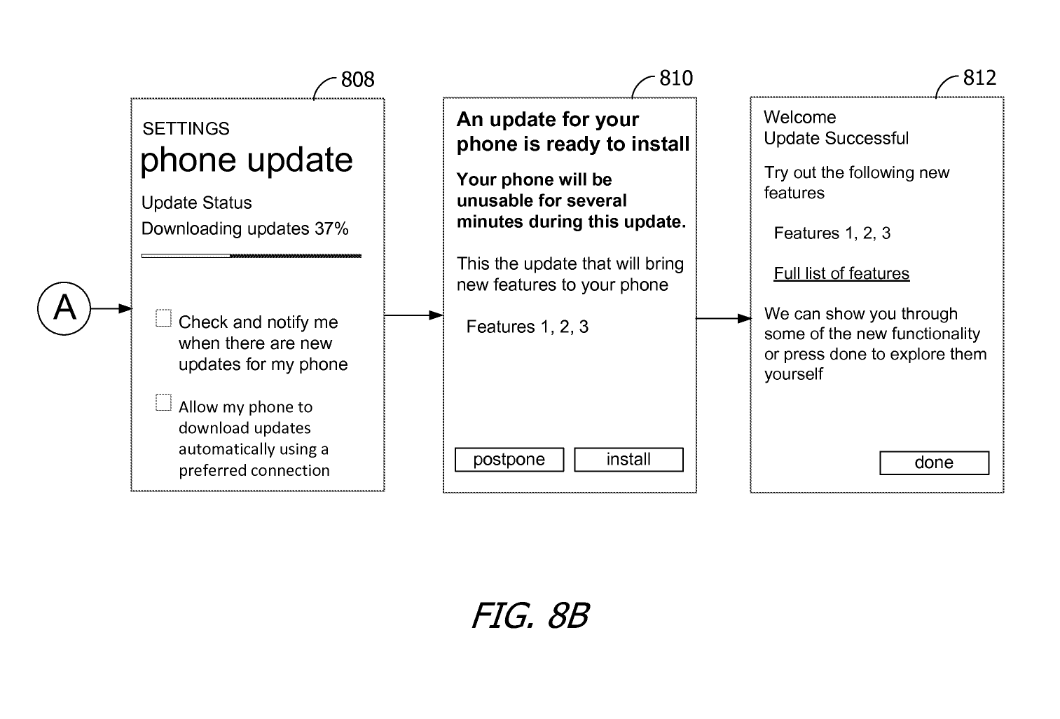

In embodiments in which the update is too large to download over a cellular network connection, downloading of the update is postponed until the user 104 connects to a Wi-Fi network connection, such as shown in FIGS. 8A and 8B below.

Referring next to FIG. 8A and FIG. 8B, an exemplary user interface flow illustrates selection and initiation of update operations when there is no remaining network data consumption available under the data usage plan 116, and a free or reduced cost network connection 130 is not available. In the example of FIG. 8A and FIG. 8B, the update operations are performed after presenting a download prompt to the user 104 to confirm performance of the update operations. Further, in this example, the update is too large to download over a cellular network connection.

The user 104 is presented with a dialog 802 indicating that an update is ready to download. The user 104 may choose to proceed with the download or to postpone the download if the user 104 is too busy or not connected to Wi-Fi. If the user 104 proceeds to attempt to download the update without first connecting to Wi-Fi, the user 104 is presented with a dialog 804 indicating that the download is suspended until the user 104 connects to Wi-Fi.

After the user 104 has connected to Wi-Fi via a dialog 806, the user 104 may be prompted to download the update over the Wi-Fi network connection (not shown) or the update may be downloaded automatically as in dialog 808. Dialog 808 shows the progress of the download.

After the update has been downloaded, the user 104 is presented with a dialog 810 indicating that an update is ready to install. The user 104 is given information about the contents of the update and the option to “postpone” or “install” the update. Postponing or dismissing the dialog 810 brings the user 104 back to the previous activity on the mobile computing device 102 and the dialog 810 is displayed again after some time period (e.g., a few days).

If the user 104 chooses to install the downloaded update, the mobile computing device 102 proceeds to install the update and displays a progress bar for the status of the installation. After committing the update, the mobile computing device 102 presents a dialog 812 showing that the update was successful and outlining a list of new features associated with the update.

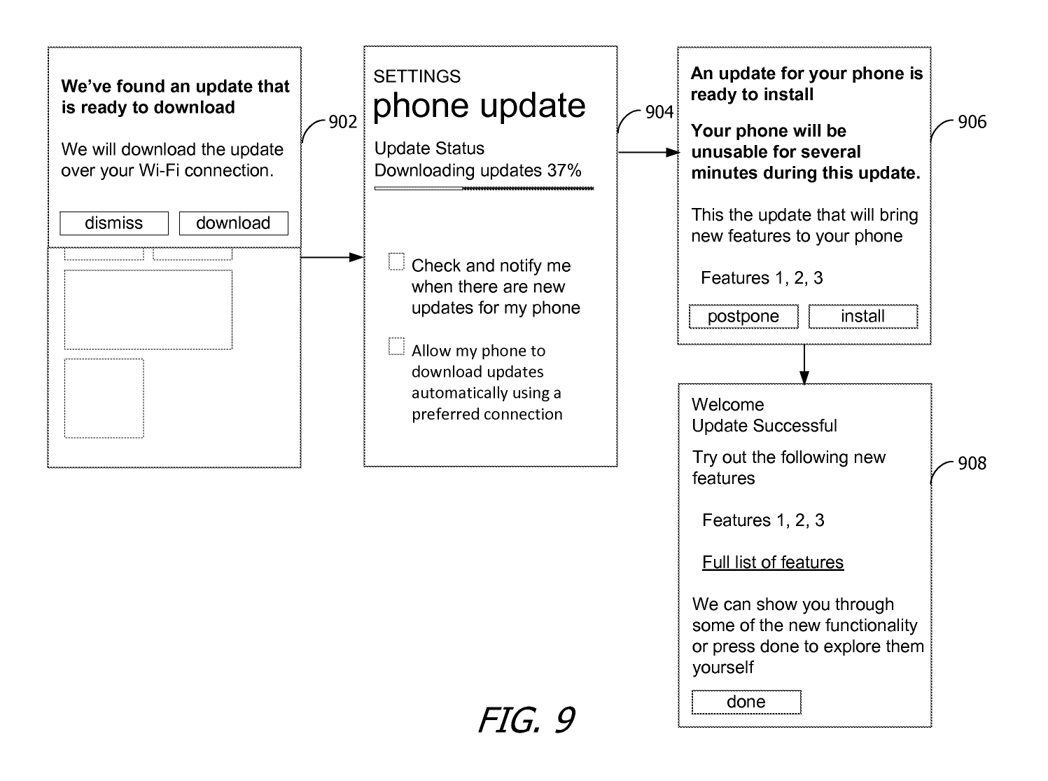

Referring next to FIG. 9, an exemplary user interface flow illustrates selection and initiation of update operations when there is remaining network data consumption available under the data usage plan 116, and a free or reduced cost network connection 130 has been established. In the example of FIG. 9, the update operations are performed after presenting a download prompt to the user 104 to confirm performance of the update operations.

The user 104 is presented with a dialog 902 indicating that an update is ready to download. The user 104 is connected to a Wi-Fi network connection, but has chosen not to enable automatic download of updates in this example. The user 104 may choose to proceed with the download or to dismiss the dialog 902 if the user 104 is busy. If the user 104 proceeds with the download, the user 104 is taken to an update settings dialog 904 that shows the progress of the download. Cancelling the dialog 902 brings the user 104 back to the previous activity on the mobile computing device 102 and the dialog 902 is displayed again after some time period (e.g., a few days).

After the update has been downloaded, the user 104 is presented with a dialog 906 indicating that the update is ready to install. The user 104 is presented with information about the contents of the update and the option to install the update now or postpone installation of the update. Dismissing the dialog 906 brings the user 104 back to the previous activity on the mobile computing device 102 and the dialog 906 is displayed again after some time period (e.g., a few days).

If the user 104 chooses to install the downloaded update, the mobile computing device 102 proceeds to install the update and displays a progress bar for the status of the installation. After committing the update, the mobile computing device 102 presents a dialog 908 showing that the update was successful and outlining a list of new features associated with the update.

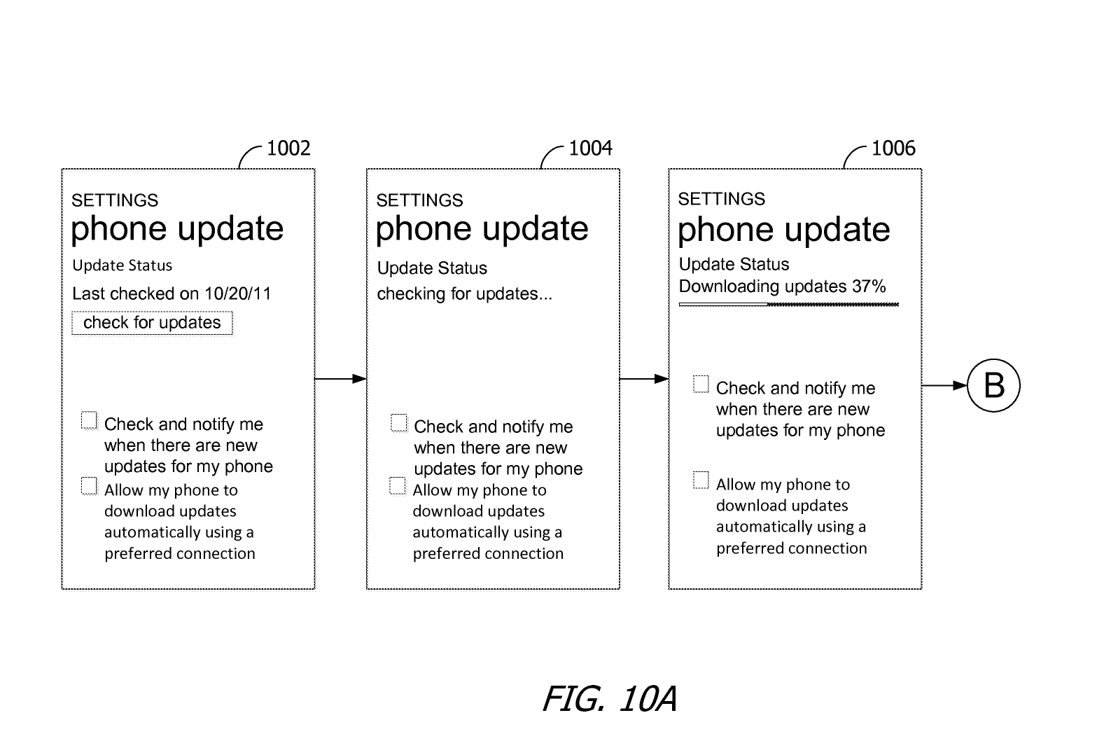

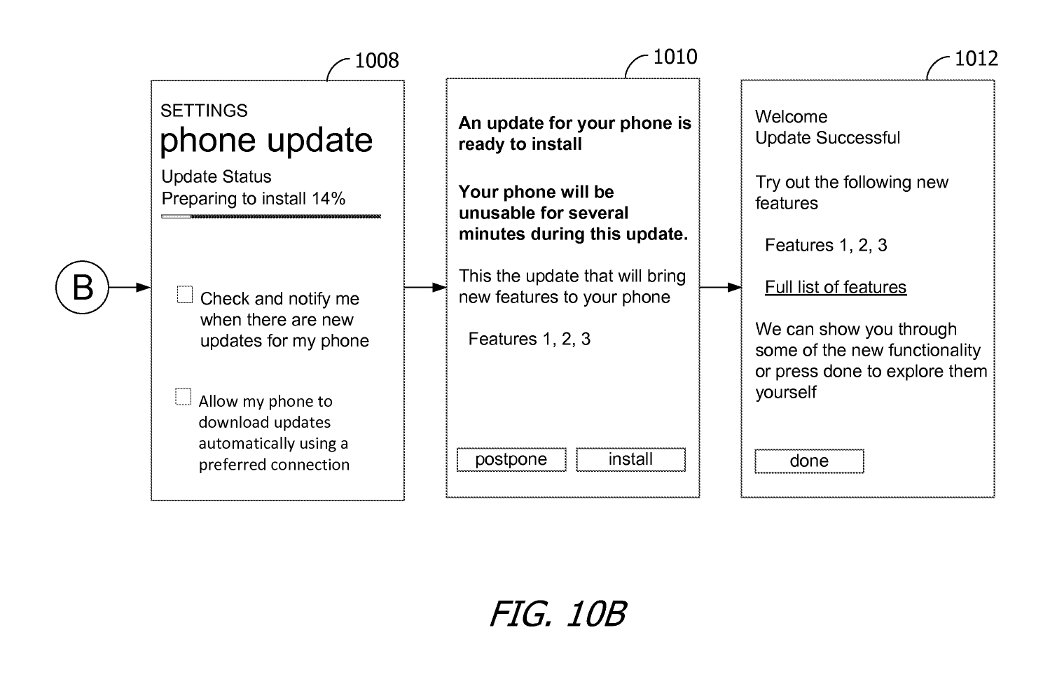

Referring next to FIG. 10A and FIG. 10B, an exemplary user interface flow illustrates selection and initiation of update operations in response to a request from the user 104. A dialog 1002 is presented to the user 104 with information about update settings and activity, including the last time a scan for updates was completed. The user 104 manually requests that a scan for updates be performed via a dialog 1002. This user-initiated check for updates bypasses any server-side throttling, making any applicable updates immediately available for download.

Dialogs 1004, 1006, 1008 indicate the status of the scan for updates. In particular, the dialog 1004 indicates that the mobile computing device 102 is checking for updates. The dialog 1006 indicates that updates are being downloaded. The dialog 1008 indicates that updates are being prepared for installation.

After the update has been downloaded, the user 104 is presented with a dialog 1010 indicating that the update is ready to install. The user 104 is presented with information about the contents of the update and the option to install the update now or postpone installation of the update. Dismissing the dialog 1010 brings the user 104 back to the previous activity on the mobile computing device 102 and the dialog 1010 is displayed again after some time period (e.g., a few days).

If the user 104 chooses to install the downloaded update, the mobile computing device 102 proceeds to install the update and displays a progress bar for the status of the installation. After committing the update, the mobile computing device 102 presents a dialog 1012 showing that the update was successful and outlining a list of new features associated with the update.

### Additional Examples

At least a portion of the functionality of the various elements in FIG. 1 may be performed by other elements in FIG. 1, or an entity (e.g., processor, web service, server, application program, computing device, etc.) not shown in FIG. 1.

In some embodiments, the operations illustrated in FIG. 3 and FIG. 5 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The term “roaming” as used herein refers, in some embodiments, to connectivity provided outside a subscriber's home zone that may be subject to additional tariffs, fees, or constraints. Roaming service may or may not be provided by the same mobile operator 111. The term “tethered” as used herein refers, in some embodiments, to situations where one device acts as an access point for another device for network access. A tethered connection may occur over a wired connection or a wireless connection. The term “Wi-Fi” as used herein refers, in some embodiments, to a wireless local area network using high frequency radio signals for the transmission of data. The term “BLUETOOTH” as used herein refers, in some embodiments, to a wireless technology standard for exchanging data over short distances using short wavelength radio transmission. The term “cellular” as used herein refers, in some embodiments, to a wireless communication system using short-range radio stations that, when joined together, enable the transmission of data over a wide geographic area. The term “NFC” as used herein refers, in some embodiments, to a short-range high frequency wireless communication technology for the exchange of data over short distances.

Embodiments have been described with reference to data monitored and/or collected from users 104. In some embodiments, notice may be provided to the users 104 of the collection of the data (e.g., via a dialog box or preference setting) and users 104 are given the opportunity to give or deny consent for the monitoring and/or collection. The consent may take the form of opt-in consent or opt-out consent.

### Exemplary Operating Environment

Aspects of the disclosure are capable of operation and/or display on any computing device or screen. For example, the user 104 may move between a mobile device, a gaming console, an in-vehicle computing system (e.g., entertainment and/or navigation), a portable media player, and a laptop.

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and are mutually exclusive to communication media. In some embodiments, computer storage media are implemented in hardware. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, embodiments of the disclosure are capable of implementation with numerous other general purpose or special purpose computing system environments, configurations, or devices.

Examples of well-known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like. Such systems or devices may accept input from the user 104 in any way, including from input devices such as a keyboard or pointing device, via gesture input, and/or via voice input.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for selectively performing backup operations in view of priority and remaining network data consumption.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for managing backup operations in view of priority and a data usage plan, said system comprising:
a memory area associated with a mobile computing device of a user, said memory area storing a plurality of data transfer requests, each of the plurality of data transfer requests representing a backup operation and having priority information associated therewith, said memory area further storing data usage statistics associated with a data usage plan associated with the mobile computing device; and
a processor programmed to:
receive the data transfer requests from one or more applications executing on the mobile computing device;
select one or more of the received data transfer requests based at least on the priority information and the data usage statistics stored in the memory area; and
initiate the selected one or more data transfer requests on a network connection available to the mobile computing device.

2. The system of claim 1, wherein the processor is programmed to select the one or more of the received data transfer requests by matching each of the one or more of the received data transfer requests to one of a plurality of network connections available to the mobile computing device based on the priority information and the data usage statistics.

3. The system of claim 1, wherein the processor is further programmed to assign the priority information to the received data transfer requests based on a priority assigned to the backup operations associated therewith.

4. The system of claim 3, wherein the processor is programmed to assign the priority information by adding each of the applications, upon execution of the application, to a most recently used (MRU) list.

5. The system of claim 4, wherein the processor is programmed to initiate the selected one or more data transfer requests by performing the backup operations as ordered in the MRU list.

6. The system of claim 1, wherein the priority information includes one or more of the following: Wi-Fi only, only when free or reduced cost network connection is available, and manually on demand by the user or application.

7. The system of claim 1, further comprising means for selectively performing backup operations in view of priority and remaining network data consumption.

8. A method comprising:
receiving a plurality of data transfer requests from one or more applications executing on a computing device, each of the plurality of data transfer requests representing an update operation;
accessing data usage statistics associated with a data usage plan associated with the computing device;
selecting one or more of the received plurality of data transfer requests based at least on the accessed data usage statistics and on an availability of a network connection of the computing device; and
initiating the selected one or more of the received plurality of data transfer requests on the network connection.

9. The method of claim 8, wherein accessing the data usage statistics includes determining an amount of network data consumed during at least a portion of a pre-defined time interval under the data usage plan by the computing device.

10. The method of claim 8, further comprising determining, before selecting the one or more of the received plurality of data transfer requests, whether one or more of the following network connections are available: a free network connection, and a reduced cost network connection.

11. The method of claim 8, further comprising determining, before selecting the one or more of the received plurality of data transfer requests, an amount of network data to be consumed by each of the received plurality of data transfer requests.

12. The method of claim 11, wherein determining the amount of the network data to be consumed includes determining a size of an update to be downloaded by the computing device from a web service.

13. The method of claim 11, further comprising comparing the determined amount of network data to be consumed for one or more of the received plurality of data transfer requests to an amount of network data consumption remaining under the data usage plan.

14. The method of claim 13, wherein initiating the selected one or more of the received plurality of data transfer requests comprises initiating the selected one or more of the received plurality of data transfer requests based on the comparison.

15. The method of claim 8, further comprising comparing the accessed current data usage statistics to a threshold value associated with the network connection to calculate remaining network data consumption, the threshold value being defined by the data usage plan.

16. The method of claim 15, wherein selecting the one or more of the received plurality of data transfer requests occurs based on the calculated remaining network data consumption.

17. One or more computer storage media embodying computer-executable components, said components comprising:
a communications interface component that when executed causes at least one processor to receive a plurality of data transfer requests from one or more applications executing on a computing device, at least one of the plurality of data transfer requests representing an update operation and at least one of the plurality of data transfer requests representing a backup operation, the backup operation having priority information associated therewith;
a backup component that when executed causes at least one processor to select the at least one of plurality of data transfer requests representing the backup operation based at least on the priority information and on data usage statistics, the data usage statistics being associated with a data usage plan associated with the computing device; and
an update component that when executed causes at least one processor to select the at least one of the plurality of data transfer requests representing the update operation based at least on the data usage statistics and on a network connection available to the computing device,
the communications interface component initiating, on the network connection, the one or more of the received plurality of data transfer requests selected by the backup component and by the update component.

18. The computer storage media of claim 17, wherein the data usage statistics represent an amount of network data consumed by the computing device during a portion of a pre-defined time interval under the data usage plan.

19. The computer storage media of claim 17, wherein the update component further determines whether the computing device is under track, on track, or off track for network data consumption compared to an amount of network data consumption allotted under the data usage plan.

20. The computer storage media of claim 17, wherein the update component further predicts future network data consumption by the user based on the plurality of data transfer requests received by the communications interface component.
